(19) United States
(12) Patent Application Publication
(10) Pub. No.: US 2005/0222927 A1
(43) Pub. Date: Oct. 6, 2005

(54) Method of guarantying a minimum cash flow for a business entity that holds a facility that converts one commodity to another commodity and related system

(76) Inventor: John A.C. Woodley, Westport, CT (US)

Correspondence Address: KIRKPATRICK & LOCKHART NICHOLSON GRAHAM LLP, 535 SMITHFIELD STREET, PITTSBURGH, PA, 15222, US

(21) Appl. No.: 10/816,387

(22) Filed: Apr. 1, 2004

(51) Int. Cl. G06F 17/60

(52) U.S. Cl. 705/35

(57) ABSTRACT

A method of guarantying a minimum cash flow for a business entity that holds at least one facility that converts a first commodity to a second commodity is disclosed. According to various embodiments, the method includes establishing a contract between the business entity and an option grantor. The contract obligates the option grantor, in exchange for a contract premium paid by the business entity to the option grantor, to pay the business entity a payment after a look-back period, when the aggregate value of one or more strips of options corresponding to one or more facilities subject to the contract is below a predetermined value, and where the value of each option in the strip is based on a spread between the price of the second commodity and the cost of producing the second commodity from the first commodity, where the price and cost are assessed based on price and cost information over the look-back period.

### BACKGROUND OF THE INVENTION

The present invention relates generally to financial transactions and, more particularly, to methods for guarantying a minimum cash flow for a business entity that holds at least one facility that converts one commodity to another commodity.

Electrical power plants convert fuel, such as natural gas, water, fuel oil or coal, into electricity. The generated electricity is sold into deregulated wholesale electric markets to third parties who ultimately resell or directly supply the electricity to consumers. Thus, the revenue of the owner or user of the power plant is dependent upon the spread between the cost of generating the electricity from the fuel (which is directly related to the price of the fuel) and the price at which the owner can sell the electricity (sometimes referred to as the “spark-spread”). In that connection, it is well understood that power plants may be economically modeled as a strip of options on spark-spreads. Such options' payoffs are a function of the time-dependent power and fuel prices, as well as the heat rate (i.e., a measure of the efficiency of the facility in converting fuel to electricity) and the costs of running the facility.

If the owner of the electrical power plant sells the output into the market without a long-term, fixed price offtake contract, the expected returns of the owner are uncertain because the spread between the fuel cost and the price of the electricity is almost certain to fluctuate over time. Due to the uncertain returns, the ability of the owner to leverage the power plant is severely diminished because a lender is unlikely to lend where there is doubt or uncertainty about the revenues received by the facility and thus the owner's ability to repay. Absent a spark-spread hedge to create a more predictable revenue stream, lenders may be unwilling to lend more, making a high debt-equity ratio unlikely for the power plant owner. Debt-equity ratio is a measure of a company's leverage, calculated by dividing long-term debt by common shareholders' equity. A company with a higher debt-equity ratio can typically offer greater returns to shareholders.

To avoid this dilemma, the power plant owner may pre-commit the plant output on a long-term fixed-price or fixed-spread basis to an offtaker. That is, the power plant owner may enter into a long-term offtake contract whereby the offtaker agrees to purchase the output for the period of the contract at either a fixed price or a fixed relationship to the price of the fuel. It should be noted that the term “owner” here refers to the person or entity that owns the operating or tolling rights of the plant, and not necessarily the title holder to the plant.

Individual power plants or fleets of power plants that are owned by independent power producers (“IPP,” i.e., entities that are not cost-of-service regulated or vertically integrated) are typically held in a special purpose vehicle (“SPV”) owned by the IPP. An SPV is a business entity formed solely in order to accomplish some specific task or tasks, in this case to own and/or manage the power plant(s). SPVs typically have limited inherent credit because the only asset(s) of the SPV are the power plants, which are not liquid enough to act as credit collateral or credit support from the parent. In order to enter into a long-term offtake contract, the offtaker has to be comfortable with the SPV's ability to perform under the contract, or there must exist some sort of guarantee or other credit support (e.g., a letter of credit or keep-well agreement with respect to the SPV's obligations under the long-term offtake contract from a credit-worthy entity, such as the IPP). In today's economic climate, however, most IPPs have impaired credit. Hence, even if the IPPs desired to offer credit support to their SPVs, they would face a dilemma of wanting to finance a plant or fleet of plants without the credit capacity to do so.

One known solution is for the power plant owner to use part of the proceeds of the financing to collateralize the obligation to sell the plant output. This, however, is at the least inefficient because the purpose of the financing in the first place is to get cash, not collateralize debt obligations, and at worst impossible because the collateral would exceed the financing proceeds. Because power prices are constrained on the down side at zero but unconstrained on the up side, a great deal of collateral is often needed to assuage the offtaker's concerns that the power plant will not deliver when prices for electricity are high, either because it is inoperative perhaps due to skimpy maintenance or because a market price increase subsequent to contracting creates an incentive to sell to third parties at the new, higher prices.

Accordingly, there exists a need for a transaction structure that guarantees a minimum cash flow to a business entity that holds one or more power plants to thereby support an efficient financing.

### SUMMARY OF THE INVENTION

In one general respect, the present invention is directed to a method of guarantying a minimum cash flow for a business entity that holds at least one facility that converts a first commodity to a second commodity. According to one embodiment, the method includes establishing a contract (e.g., a put) between the business entity and an option grantor. The contract obligates the option grantor, in exchange for a contract premium paid by the business entity to the option grantor, to pay the business entity a payment after a look-back period when the aggregate value of one or more strips of options corresponding to one or more facilities subject to the contract is below a predetermined value, and where the value of each option in the strip is based on a spread between the price of the second commodity and the cost of producing the second commodity from the first commodity. The price and cost are assessed based on price and cost information over the look-back period.

According to various embodiments, the business entity may pay the premium with proceeds from a financing, such as a debt offering to investors, by the business entity. Additionally, the business entity may enter into a series of such contracts with the option grantor covering a series of consecutive look-back periods. In addition, the method may include a third-party guarantor guarantying payment obligations of the option grantor under the contract. And, the method may be applied when the facility or portfolio of facilities has a partial offtake contract, or other hedge contract, to supplement the certainty of cashflows to lenders beyond that provided by the offtake contracts.

In another general respect, the present invention is directed to a system. According to one embodiment, the system includes a computing device for determining whether the option grantor is required to pay the business entity the payout under the contract, and, if so, for computing the payout amount. In addition, the computing device may electronically transfer the payout from an account of the option grantor to an account of the business entity when the payout under the contract is triggered.

### DESCRIPTION OF THE FIGURES

Embodiments of the present invention will be described by way of example in conjunction with the following figures, wherein:

FIG. 1 is a diagram of a financial transaction structure according to various embodiments of the present invention;

FIG. 2 is a diagram of a method according to various embodiments of the present invention; and

FIG. 3 is a diagram of a system according to various embodiments of the present invention.

### DETAILED DESCRIPTION OF THE INVENTION

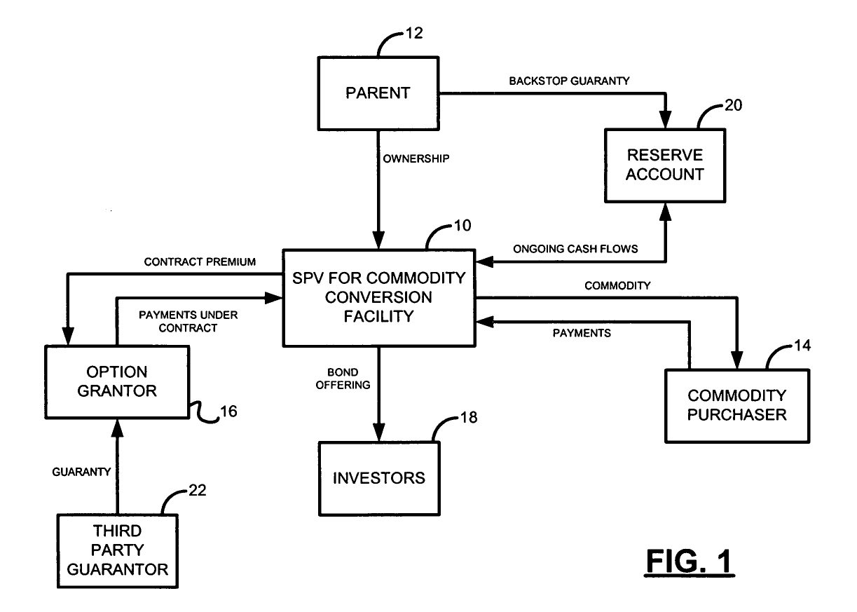

FIG. 1 is a diagram of a transaction structure to guarantee a minimum cash flow for a business entity 10 holding a facility or fleet of facilities that converts one commodity (the “original commodity”) into another commodity (the “converted commodity”) according to various embodiments of the present invention. The business entity 10 may be a special purpose vehicle (“SPV”). An SPV is a business interest formed solely in order to accomplish some specific task or tasks. In this case, the SPV may hold one or more commodity conversion facilities. The commodity conversion facility may be, for example, a power plant that converts fuel (such as gas, fuel oil, water or coal) to electrical power, or it may be a refinery that converts crude oil into refined products such as heating oil and gasoline. For purposes of convenience, the business entity 10 will be referred to in the following description as an SPV, although it should be recognized that the business entity 10 holding the one or more commodity conversion facilities may assume a different business entity structure.

The SPV 10 may be owned, directly or through one or more intermediary business entities, by a parent 12. For the example where the commodity conversion facility is an electrical power plant, the parent 12 may be an IPP that holds the one or more power plants in the SPV 10.

According to various embodiments, the SPV 10 may sell the converted commodity on the market, such as a spot market, to a commodity purchaser 14 in exchange for cash or some other valuable good. Only one commodity purchaser 14 is shown in FIG. 1, but it should be understood that the SPV 10 might sell the converted commodity to multiple commodity purchasers.

In order to give the SPV 10 the financial flexibility so that it does not have to enter into a long-term offtake contract with a commodity purchaser, the SPV 10 may enter into one or a series of contracts with an option grantor 16 according to various embodiments of the present invention. The contracts (e.g., puts) may require the option grantor 16 to pay the SPV 10 a payment when a value, dependent upon the value of a strip (or series) of options on the price spread between (i) the cost of making the second commodity from the first commodity and (ii) the price of the second commodity, summed over all conversion commodity facilities specified in the contract, is below a threshold value (e.g., the strike price of the put) specified in the contract over a retrospective look-back period specified in the contract. According to some variations, the threshold value may be compared to the sum of the values of the strip of options in determining whether a payment is due under the contracts. According to other variations, for example, the threshold value may be compared to a value otherwise related to the sum of the values of the strip of options, such as the sum with carried interest over the look back period, in determining whether a payment is due under the contracts.

The look-back period may be, for example, 6 months, one year, etc. The payment may be equal to the difference between the value specified in the contract and a value related to the value of the strip of options on the spreads, as described above. The SPV 10 pays the option grantor 16 a contract premium for entering into the contract. The SPV 10 may pay the premium with proceeds from a financing, as explained below.

The options on the price spread in the strip (or series) may be for time segments that correspond to the flexibility period of the conversion commodity facility such as, for example, a number of hours, a number of days, etc. The value of each option of the strip of options may be computed based on the difference between (i) the price of the second commodity and (ii) the cost of the facility to produce the second commodity from the first commodity. If the price of the second commodity is greater than the cost of producing the second commodity, the value of the option is equal to the difference. If the price of the second commodity is less than the cost of producing the second commodity, the value of the option equals zero.

Below is a chart illustrating an example. Assume the facility converts coal to electricity and the options may be exercised daily. The cost of producing the second commodity is related to the price of coal (x), the rate to convert the coal to electricity (a), and the daily operating costs of the facility (b). On Day 1 the price of coal is $3. If the conversion rate is 10 and the plant costs are $5, the cost of producing electricity for Day 1 is $35. Since the price of electricity is $100 on Day 1, the value of the option for Day 1 is $65. As can be seen in the chart below, on Days 3 and 4 the cost of producing electricity is greater than the price, so the value of the options for these days is zero.

| | Price of | Conversion | | Cost of Producing Elec. | | Value of |
|---|---|---|---|---|---|---|
| Day | Coal (x) | Rate (a) | Plant Cost (b) | (ax + b) | Price of Elec. | Option |
| 1 | 3 | 10 | 5 | 35 | 100 | 65 |
| 2 | 5 | 10 | 5 | 55 | 75 | 20 |
| 3 | 6 | 10 | 5 | 65 | 60 | 0 |
| 4 | 7 | 10 | 5 | 75 | 60 | 0 |

This calculation may be made for each option in the strip of options. At the end of the look-back period, if the sum (or a value related to the sum) of the value of the options is less than the value specified in the contract between the option grantor 16 and the SPV 12, the option generator 16 makes a payment to the SPV equal to the difference. If the sum (or a value related to the sum) of the value of the options is equal to or greater than the value specified in the contract, the option grantor 16 is not obligated to make a payment to the SPV 12. This calculation may be made for each facility of the SPV 10 covered by the contract. Further, the valuations may be done based on publicly available price indices, such as the price indices for the price of coal and the price of electricity for the above example.

In this way, the SPV 10 may be guaranteed a minimum cash flow. For example, if the value of the strip of options is too low over the look-back period, thus impairing the ability of the SPV 10 to generate revenue by selling the converted commodity, the payments from the option grantor 16 will be triggered, providing the SPV 10 a minimum cash flow on the down-side The cash flow of the SPV 10 need not be capped on the up-side because, if the value of the strip of options was favorable for the SPV 10, and thus not below the set level of the contract, the SPV 10 may sell the converted commodity at, for example, market prices.

In more general terms, the option grantor 16 may be required to pay the SPV 10 the payment after the look-back period when the aggregate value of one or more strips of options corresponding to one or more facilities subject to the contract is below the predetermined value specified in the contract, and where the value of each option in the strip is based on a spread between the price of the second commodity and the cost of producing the second commodity from the first commodity. The price and cost may be assessed based on price and cost information, such as indices, over the look-back period.

The option grantor 16 may grant one or a series of such contracts to the SPV 10. The contracts may be structured as financial contracts and, hence, independent of the commodity conversion facility or facilities held by the SPV 16. Where a series of options is granted, the options may respectively cover consecutive look-back periods and the periods may correspond to dates on which debt service obligations become due. For example, the option grantor 16 may grant a number of consecutive one-year look-back options to the SPV 10, for example, whereby the option grantor 16 is to pay the SPV 10, for each of the series of options, if the spread price was below the predetermined level in the preceding year. According to various embodiments, the predetermined spread price at which payments by the option grantor 16 are triggered may remain the same for each of the consecutive options or may vary depending on, for example, economic forecasts.

The SPV 10 may generate the proceeds to pay the contract premium to the option grantor 16 through a financing such as, for example, the offering of debt securities (e.g., bonds) to investors 18. For example, the SPV 10 may offer notes to investors 18 in, for example, the Rule 144A/Reg. S market. In order to pay the principal and interest on the notes to the investors 18 as they become due, a reserve account 20 associated with the SPV 10 may maintain sufficient funds to cover the principal and interest payments for a specified time period (such as a number of months). The SPV 10 may hold at least a portion of cash revenue, such as from the receipt of cash due to selling the converted commodity and/or the contract payments from the option grantor 16, in the reserve account 20 and may make payments, such as for the original commodity, from the account 20.

In addition, according to various embodiments, a backstop guaranty may guarantee that sufficient funds are maintained in the reserve account 20 to cover the principal and interest on the notes for the specified time period. According to one embodiment, the parent 12 of the SPV 10 may provide the backstop guarantee, as illustrated in FIG. 1, although according to other embodiments another party or parties may provide the backstop guaranty.

Further, as illustrated in FIG. 1, a third-party guarantor 22 may guarantee the payment obligations, i.e., the contract payments, of the option grantor 16 to the SPV 10. According to various embodiments, the third-party guarantor 22 may be affiliated with the option grantor 16. For example, the third-party guarantor 22 may own the option grantor 16.

Despite the backstop guaranty and the guaranty by the third-party guarantor 22 of the option grantor's 16 payment obligations, the investors 18 may still face risk. For example, where the commodity conversion facility is a power plant, the investors 18 may bear unit-contingent risks, such as unforced outages of the plant.

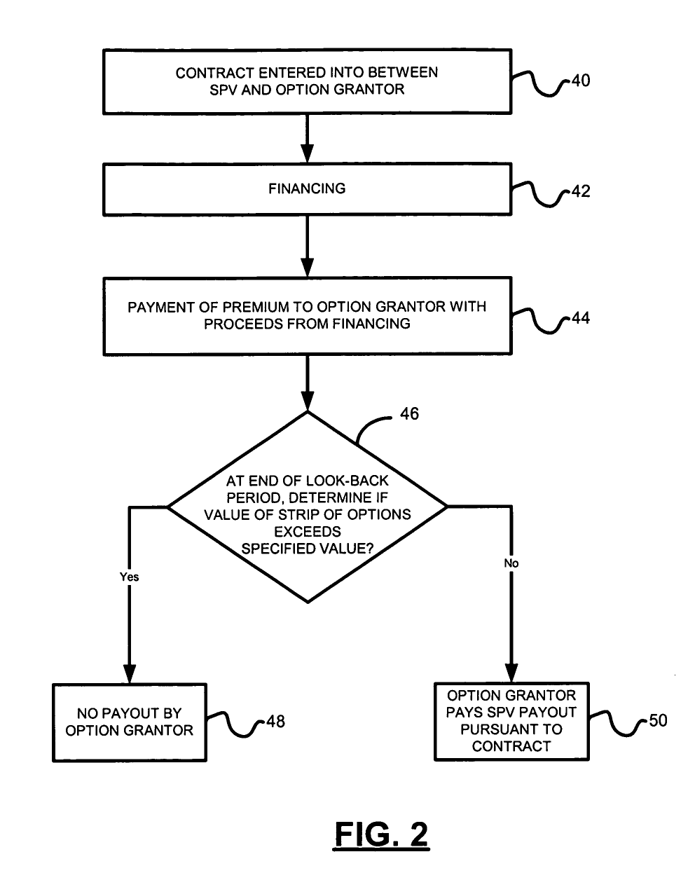

FIG. 2 is a flowchart of the method according to various embodiments. At block 40, the SPV 10 and option grantor 16 may enter into the contract (or series of contracts covering successive look-back periods). As mentioned before, the contract has a specified look-back period, such as, for example, six months, one year, etc. At block 42, the SPV 10 may do the financing, such as offering debt securities to investors 18. At block 44, the SPV 10 pays the option grantor 16 the premium for the contract with proceeds from the financing at block 42. At block 46, at the end of the look-back period, it is determined whether the value of the strip of options on the price spread exceeded the predetermined value specified in the contract or not. This determination may be made with reference to price indices for the original and converted commodities. A computing device, for example, may perform this step, as explained below. If the sum (or a value related to the sum) of the values of the strip of options on the spreads exceeded the specified strike value, the option grantor 16 need not make the payout to the SPV (block 48). On the other hand, if sum (or a value related to the sum) of the values of the strip of options on the spreads did not exceed the specified value, then, pursuant to the terms of the contract, the option grantor 16 would make the required payout to the SPV 10 (block 50). Where the SPV 10 and the option grantor 16 enter into a series of contracts covering successive look back periods, steps 46-50 may be repeated for each contract. It should be noted that the steps shown in FIG. 2 might be performed in various orders.

By way of example, consider the case of a commodity conversion facility that converts fuel to electrical power, i.e., a power plant. In such a scenario, the contract(s) between the option grantor 16 and SPV 12 may cover a six-month look-back period. The contract(s) may provide that, at the end of the look-back period, the option grantor shall owe the SPV 12 an amount, if any, equal to the amount by which the strike price of the contract exceeds the aggregate spark spread amount for the look-back period. The “aggregate spark spread amount” may be the sum of all individual daily plant spark spread amounts for each plant over the look-back period for each on-peak operating day (e.g., all weekdays except holidays) of the respective plants. The “daily plant spark spread amount” may be an amount, in dollars, calculated for each on-peak operating day, separately for each plant subject to the contract, as:
α×max([PP−(GP×AHR)−VOM],0)
where “Δ” is a scale factor which can be individualized for each plant subject to the contract, “PP” is an index price for power, “GP” is an index price for the fuel, “AHR” is the applicable heat rate for the plant, and “VOM” is the variable operations and maintenance costs for each plant. As can be seen from this equation, if PP<(GP×AHR)+VOM for a particular plant for a particular day, then the daily plant spark spread amount for that day for that plant is zero.

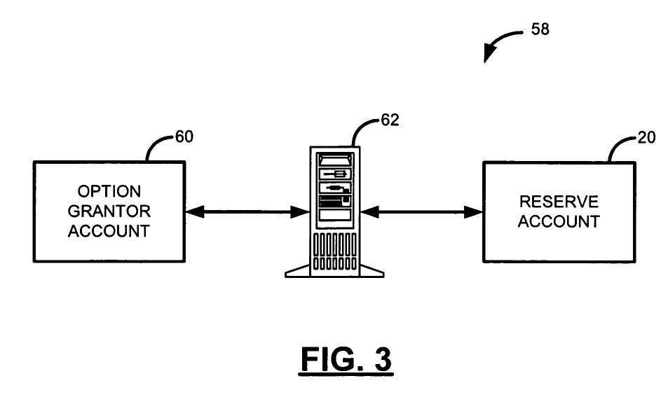

FIG. 3 is a diagram of a system 58 for facilitating implementation of the method according to various embodiments. As shown in FIG. 3, the system 58 may include the reserve account 20 of the SPV 10 in communication with an account 60 of the option grantor 16 via a computing device 62. The computing device 62 may be in communication with the accounts 20, 60 via, for example, conventional data communication links. The computing device 62, according to various embodiments, may calculate whether the option grantor 16 is required to make the contract payout to the SPV 10 and, if so, the amount of the payout. As mentioned previously, the amount of the payout may be dependent upon, for example, price indices for the original and converted commodity. In addition, if the option grantor 16 is required to pay the SPV 10 under the contract, the computing device may electronically transfer or cause the electronic transfer of the appropriate sums from the option grantor account 60 to the SPV's reserve account 20. In FIG. 3, the computing device 62 is shown as a single unit for purposes of convenience, but it should be recognized that the computing device 62 may comprise a number of distributed or networked computing devices, inside and/or outside the same administrative domain.

In order to calculate whether the payout is to be made by the option grantor 16, the computing device 62 may execute a series of instructions. The instructions may be software code to be executed by the computing device 62. The software code may be stored as a series of instructions or commands on a computer readable medium, such as a random access memory (RAM), a read only memory (ROM), a magnetic medium such as a hard drive or a floppy disk, or an optical medium such as a CD-ROM, and may be written in any suitable computer language such as, for example, Java, C, or C++ using, for example, conventional or object-oriented techniques.

Another variation on the above-described transaction structure would be to have the SPV enter into a physical offtake contract with an offtaker, wherein the offtaker pays the SPV based on a spot market (or index) price, or on a function of both fuel and power spot (or index) prices. This does not expose the offtaker to credit risk because the offtaker gains title to the plant output prior to having to pay for it. Then the agreement between the SPV and option grantor would be to guarantee that payments under this physical offtake arrangement would meet or exceed some minimum level.

While several embodiments of the invention have been described, it should be apparent that various modifications, alterations and adaptations to those embodiments may occur to persons skilled in the art. For example, the steps illustrated in FIG. 2 may be performed in various orders. It is therefore intended to cover all such modifications, alterations and adaptations without departing from the scope and spirit of the present invention as defined by the appended claims.

1. A method of guarantying a minimum cash flow for a business entity that holds at least one facility that converts a first commodity to a second commodity, comprising:
establishing a contract between the business entity and an option grantor, wherein the contract obligates the option grantor, in exchange for a contract premium paid by the business entity to the option grantor, to pay the business entity a payment after a look-back period, when the aggregate value of one or more strips of options corresponding to one or more facilities subject to the contract is below a predetermined value, and where the value of each option in the strip is based on a spread between the price of the second commodity and the cost of producing the second commodity from the first commodity, where the price and cost are assessed based on price and cost information over the look-back period.

2. The method of claim 1, wherein the aggregate value of one strip of options corresponding to one facility is equal to the sum of the values of each option in the strip for the facility.

3. The method of claim 1, wherein the aggregate value of one strip of options corresponding to one facility is related to the sum of the values of each option in the strip for the facility.

4. The method of claim 1, wherein the price and cost information are price indices for the first and second commodity specified in the contract.

5. The method of claim 1, further comprising the business entity paying the premium to the option grantor with proceeds from a financing.

6. The method of claim 5, wherein the financing includes a debt offering.

7. The method of claim 1, wherein the look-back period is selected from the group consisting of six months and one year.

8. The method of claim 1, further comprising the business entity and the option grantor establishing a second contract covering a successive look-back period.

9. The method of claim 1, further comprising a third-party guarantor guarantying payment obligations of the option grantor under the contract.

10. A method of guarantying a minimum cash flow for a business entity that holds a facility that converts a first commodity to a second commodity, comprising:
an option grantor entering into a contract with the business entity, wherein the contract obligates the option grantor to pay the business entity a payment when the aggregate value of one or more strips of options corresponding to one or more facilities subject to the contract is below a predetermined value, and where the value of each option in the strip is based on a spread between price of the second commodity and the cost of producing the second commodity from the first commodity, and wherein the price and cost are assessed based on price and cost information over the look-back period; and
the option grantor receiving a premium in exchange for entering into the contract.

11. The method of claim 10, further comprising a third-party guarantor guarantying payment obligations of the option grantor under the contract.

12. A system, comprising a computing device for determining whether an option grantor is required to pay a business entity a payout under a contract, wherein the business entity holds at least one facility that converts a first commodity to a second commodity, and wherein the contract obligates the option grantor, in exchange for a contract premium paid by the business entity to the option grantor, to pay the business entity a payment after a look-back period, when the aggregate value of one or more strips of options corresponding to one or more facilities subject to the contract is below a predetermined value, and where the value of each option in the strip is based on a spread between the price of the second commodity and the cost of producing the second commodity from the first commodity, where the price and cost are assessed based on price and cost information over the look-back period.

13. The system of claim 12, wherein the aggregate value of one of the strips of options corresponding to one facility is equal to the sum of the values of each option in the strip for that facility.

14. The system of claim 12, wherein the aggregate value of one of the strips of options corresponding to one facility is related to the sum of the values of each option in the strip for that facility.

15. The system of claim 12, wherein the computing device is further for computing the payment amount when it is determined that the option grantor is required to pay the business entity.

16. The system of claim 15, wherein the computing device is further for electronically transferring the payment from an account of the option grantor to an account of the business entity when it is determined that the option grantor is required to pay the business entity.

17. A computer readable medium having stored thereon instructions which, when executed by a computing device, cause the computing device to:
determine whether an option grantor is required to pay a business entity a payout under a contract, wherein the business entity holds at least one facility that converts a first commodity to a second commodity, and wherein the contract obligates the option grantor, in exchange for a contract premium paid by the business entity to the option grantor, to pay the business entity a payment after a look-back period, when the aggregate value of one or more strips of options corresponding to one or more facilities subject to the contract is below a predetermined value, and where the value of each option in the strip is based on a spread between the price of the second commodity and the cost of producing the second commodity from the first commodity, where the price and cost are assessed based on price and cost information over the look-back period.

18. The computer readable medium of claim 17, having further stored thereon instructions which, when executed by the computing device, cause the computing device to:
compute the payment amount when it is determined that the option grantor is required to pay the business entity.

19. The computer readable medium of claim 18, having further stored thereon instructions which, when executed by the computing device, cause the computing device to:
electronically transfer the payment from an account of the option grantor to an account of the business entity when it is determined that the option grantor is required to pay the business entity.

20. A method of guarantying a minimum cash flow for a business entity that holds at least one facility that converts a first commodity to a second commodity, comprising:
the business entity entering into an offtake contract with an offtaker, wherein the offtake contract obligates the offtaker to pay the business entity for output of the second commodity based on at least one of a spot market price and an index price for the second commodity; and
the business entity entering into a contract with an option grantor, wherein the contract obligates the option grantor, in exchange for a contract premium paid by the business entity to the option grantor, to pay the business entity a payment when the sum of payments from the offtaker to the business entity is below a predetermined value over a look-back period.

21. The method of claim 20, wherein the offtake contract obligates the offtaker to pay the business entity for output of the second commodity based on a function of the price of the first and second commodities.
